(19) United States
(12) Patent Application Publication
(10) Pub. No.: US 2026/0222931 A1
(43) Pub. Date: Jul. 30, 2026

(54) ACCESSING NES CELL

(71) Applicant: LENOVO (BEIJING) LIMITED, Beijing (CN)

(72) Inventors: Ran Yue, Beijing (CN); Min Xu, Beijing (CN); Haiming Wang, Beijing (CN); Lianhai Wu, Beijing (CN)

(21) Appl. No.: 19/147,375

(22) PCT Filed: Jan. 13, 2023
(86) PCT No.: PCT/CN2023/072103

§ 371 Date: Jul. 11, 2025

(51) Int. Cl. H04W 36/00

(52) U.S. Cl. CPC H04W 36/008355; H04W 36/00837

(57) ABSTRACT

Methods and apparatuses for determining a cell for accessing are disclosed. In one embodiment, a UE comprises a processor; and a transceiver coupled to the processor, wherein, the UE supports network energy saving (NES), and the processor is configured to receive, via the transceiver, a first information associated with accessing an anchor cell and one or more non-anchor cells; and determine, from the anchor cell and the one or more non-anchor cells, one cell as a cell for accessing, according to a predetermined condition.

### FIELD

The subject matter disclosed herein generally relates to wireless communications, and more particularly relates to methods and apparatuses for accessing a network energy saving (NES) cell.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), master information block (MIB), synchronization signal block (SSB), system information block (SIB), network energy saving (NES), random access channel (RACH), Reference Signal Receiving Power (RSRP), layer 1 (L1), layer 2 (L2), layer 3 (L3), Public Land Mobile Network (PLMN), Master Cell group (MSG), Secondary Cell group (SCG), Primary Cell (PCell), Secondary Cell (SCell), Primary Secondary Cell (PSCell).

It was agreed that UE can camp on an anchor cell. When a UE in RRC_IDLE state or RRC_INACTIVE state camps on the anchor cell, the UE can only transit to RRC_CONNECTED state via the anchor cell on which it camps.

This invention targets accessing a network energy saving (NES) cell.

### BRIEF SUMMARY

Methods and apparatuses for determining a cell for accessing are disclosed.

In one embodiment, a UE comprises a processor; and a transceiver coupled to the processor, wherein, the UE supports network energy saving (NES), and the processor is configured to receive, via the transceiver, a first information associated with accessing an anchor cell and one or more non-anchor cells; and determine, from the anchor cell and the one or more non-anchor cells, one cell as a cell for accessing, according to a predetermined condition.

In some embodiment, the predetermined condition includes a first predetermined condition, wherein the first predetermined condition includes one of: Condition 1-1: one of the one or more non-anchor cells, the quality of each of which is better than the quality of the anchor cell; Condition 1-2: one of the one or more non-anchor cells, each of which satisfies cell reselection criteria; Condition 1-3: one of the one or more non-anchor cell(s), each of which satisfies cell selection criteria; Condition 1-4: one of the one or more non-anchor cells, the quality of each of which is better than a threshold; Condition 1-5: one of the one or more non-anchor cells, each of which satisfies suitable cell definition or acceptable cell definition; and Condition 1-6: one of the one or more non-anchor cells, each of which satisfies at least two of Conditions 1-1, 1-2, 1-3, 1-4 and 1-5. The anchor cell is determined as the cell for accessing if no non-anchor cell is determined according to the first predetermined condition.

Alternatively, the predetermined condition includes a first predetermined condition, wherein the first predetermined condition includes one of: Condition 1′-2: one of the anchor cell and the one or more non-anchor cells, each of which satisfies cell reselection criteria; Condition 1′-3: one of the anchor cell and the one or more non-anchor cells, each of which satisfies cell selection criteria; Condition 1′-4: one of the anchor cell and the one or more non-anchor cells, the quality of each of which is better than a threshold; Condition 1′-5: one of the anchor cell and the one or more non-anchor cells, each of which satisfies suitable cell definition or acceptable cell definition; and Condition 1′-6: one of the anchor cell and the one or more non-anchor cells, each of which satisfies at least two of Conditions 1′-2, 1′-3, 1′-4 and 1′-5.

In some embodiment, the cell for accessing is determined according to an indication from the network.

In some embodiment, the first information associated with accessing the one or more non-anchor cells is received from one or more anchor cells; and if the UE is configured with a second cell or a cell group that includes the second cell where the second cell is one of the one or more anchor cells, the second cell or the cell group that includes the second cell is not allowed to be deactivated.

In some embodiment, the predetermined condition includes a second predetermined condition and a third predetermined condition, candidate cells are determined from the anchor cell and the one or more non-anchor cells according to the second predetermined condition, wherein, the candidate cells include the anchor cell and candidate non-anchor cell(s), and the cell for accessing is determined from the determined candidate cells according to the third predetermined condition.

In some embodiment, the second predetermined condition includes one of Condition 3-1: the one or more non-anchor cells, the quality of each of which is better than the quality of the anchor cell; Condition 3-2: the one or more non-anchor cells, each of which satisfies cell reselection criteria; Condition 3-3: the one or more non-anchor cells, each of which satisfies cell selection criteria; Condition 3-4: the one or more non-anchor cells, the quality of each of which is better than a threshold; Condition 3-5: the one or more non-anchor cells, each of which satisfies suitable cell definition or acceptable cell definition; and Condition 3-6: the one or more non-anchor cells, each of which satisfies at least two of Conditions 3-1, 3-2, 3-3, 3-4 and 3-5.

In some embodiment, the third predetermined condition includes one of Condition 4-1: one of the candidate non-anchor cell(s), the quality of each of which is better than the quality of the anchor cell; Condition 4-2: one of the candidate non-anchor cell(s), each of which satisfies cell reselection criteria; Condition 4-3: one of the candidate non-anchor cell(s), each of which satisfies cell selection criteria; Condition 4-4: one of the candidate non-anchor cell(s), the quality of each of which is better than a threshold; Condition 4-5: one of the candidate non-anchor cell(s), each of which satisfies suitable cell definition or acceptable cell definition; and Condition 4-6: one of the candidate non-anchor cell(s), each of which satisfies at least two of Conditions 4-1, 4-2, 4-3, 4-4 and 4-5. The anchor cell is determined as the cell for accessing if no non-anchor cell is determined according to the third predetermined condition.

Alternatively, the third predetermined condition includes one of Condition 4′-2: one of the candidate cells, each of which satisfies cell reselection criteria; Condition 4′-3: one of the candidate cells, each of which satisfies cell selection criteria; Condition 4′-4: one of the candidate cells, the quality of each of which is better than a threshold; Condition 4′-5: one of the candidate cells, each of which satisfies suitable cell definition or acceptable cell definition; and Condition 4′-6: one of the candidate cells, each of which satisfies at least two of Conditions 4′-2, 4′-3, 4′-4 and 4′-5.

In some embodiment, the cell for accessing is determined at one of Timing 2-1: the UE is triggered to perform state transition; Timing 2-2: the UE that camps on an anchor cell receives the first information associated with accessing the one or more non-anchor cells from the anchor cell; Timing 2-3: the UE that camps on an anchor cell receives updated first information associated with accessing some or all of the one or more non-anchor cells from the anchor cell; and Timing 2-4: after determining candidate cells.

In some embodiment, the candidate cells are determined at one of Timing 5-1: the UE is triggered to perform state transition; Timing 5-2: the UE that camps on an anchor cell receives the first information associated with accessing the one or more non-anchor cells from the anchor cell; and Timing 5-3: the UE that camps on an anchor cell receives updated first information associated with accessing some or all of the one or more non-anchor cells from the anchor cell.

In another embodiment, a method performed by a UE that supports network energy saving (NES) comprises receiving a first information associated with accessing an anchor cell and one or more non-anchor cells; and determining, from the anchor cell and the one or more non-anchor cells, one cell as a cell for accessing, according to a predetermined condition.

In still another embodiment, a network device comprises a processor; and a transceiver coupled to the processor, wherein, the network device manages an anchor cell, and the processor is configured to transmit, via the transceiver, a first information associated with accessing the anchor cell and one or more non-anchor cells; and indicate, to a UE, a cell for accessing from the anchor cell and the one or more non-anchor cells.

In yet another embodiment, a method performed by a network device, wherein, the network device manages an anchor cell, and the method comprises transmitting a first information associated with accessing the anchor cell and one or more non-anchor cells; and indicating, to a UE, a cell for accessing from the anchor cell and the one or more non-anchor cells.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIGS. 1(a) and 1(b) illustrate two example scenarios of an anchor cell and two NES cells;

FIG. 2 is a schematic flow chart diagram illustrating an embodiment of a method;

FIG. 3 is a schematic flow chart diagram illustrating a further embodiment of a method; and

FIG. 4 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, 3GPP NR-U, NR Radio Access operating with shared spectrum channel access and so on. It is contemplated that along with the developments of network architectures and new service scenarios, all embodiments in the present application are also applicable to similar technical problems. Moreover, the terminologies recited in the present application may change, which should not affect the principle of the present application. Embodiments of the present disclosure can also be applied to unlicensed spectrum scenario.

To make description clearer, a few concepts are clarified.

NES UE can be also referred to a NES capable UE, or a UE that supports NES technologies, or a UE with the capability to support NES technologies.

An anchor cell is a cell where UE assumes that the cell transmits SSB, system information and paging. A non-anchor cell is a cell that at least does not transmit system information (SI). In particular, a non-anchor cell is a cell that neither transmits SSB nor transmits SIBs, or a cell that transmits SSB but does not transmit SIB(s) (which can be referred to as SIB-less cell). The SIB-less cell may transmit MIB or does not transmit MIB.

A NES cell is a cell that supports NES technologies.

Although an anchor cell can be a NES cell, in this disclosure, it is assumed that a NES cell is an example of non-anchor cell.

NES UE can identify or access to or connect to a non-anchor cell (e.g., NES cell) by obtaining at least the necessary information for accessing (e.g., SSB and/or SIB) the non-anchor cell. The necessary information for accessing the non-anchor cell may be the system information of the non-anchor cell. Alternatively, the necessary information for accessing the non-anchor cell may be a part of the system information of the non-anchor cell (which implies that the system information of the non-anchor cell may include other information that is not used for accessing the non-anchor cell). If the necessary information for accessing a non-anchor cell or the system information of the non-anchor cell is received by UE, the UE can access the non-anchor cell. So, the necessary information for accessing a non-anchor cell is associated with the non-anchor cell and can be referred to as necessary information for accessing associated with a non-anchor cell.

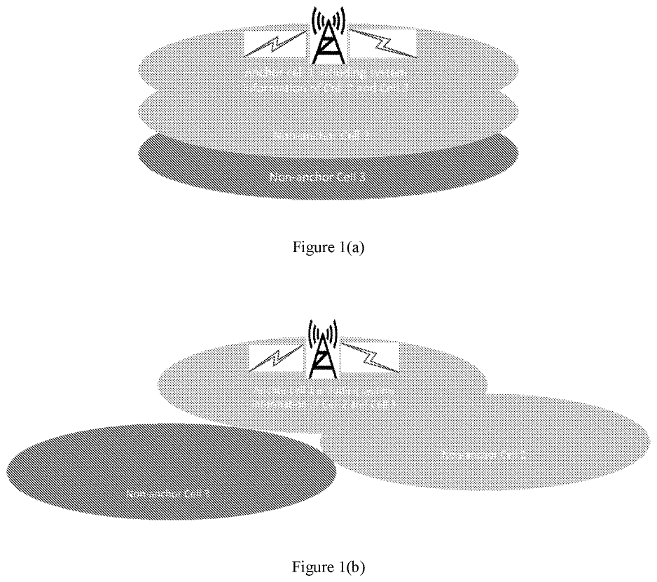

FIGS. 1(a) and 1(b) illustrate two example scenarios of an anchor cell and two non-anchor cells. In both FIGS. 1(a) and 1(b), cell 1 is the anchor cell. Cell 1 transmits the necessary information for accessing cell 2 and cell 3. Each of cell 2 and cell 3 is a non-anchor cell. In FIG. 1(a), anchor cell 1 has the same coverage as each of non-anchor cell 2 and non-anchor cell 3. In FIG. 1(b), each of anchor cell 1, non-anchor cell 2 and non-anchor cell 3 has a different coverage.

The anchor cell, which has the knowledge about the necessary information for accessing non-anchor cell(s) (e.g., the non-anchor cell(s) that are the neighbor cells of the anchor cell), can broadcast the necessary information for accessing the non-anchor cell(s), or send necessary information for accessing non-anchor cell(s) upon receiving a request for the necessary information for accessing the non-anchor cell(s) from the UE.

In this disclosure, it is assumed that the UE (which is in RRC_IDLE state or RRC_INACTIVE state) camps on an anchor cell, and receives the necessary information for accessing non-anchor cells from the anchor cell. It is possible that the UE receives the system information of the non-anchor cell(s) each of which includes the necessary information for accessing one of the non-anchor cell(s). For a first example, the anchor cell may broadcast the system information of non-anchor cell(s) (e.g., the non-anchor cell(s) are the neighbor cell(s) of the anchor cell) or the necessary information for accessing the non-anchor cell(s). For a second example, the UE may request for the system information of the non-anchor cell(s) or the necessary information for accessing the non-anchor cell(s) from the anchor cell. The detailed implementation of receiving the system information of non-anchor cells or the necessary information for accessing the non-anchor cells is out of the scope of this disclosure.

In addition, the UE may store and/or use the necessary information for accessing the non-anchor cells (or the system information of non-anchor cells). For a first example, when the UE camps on an anchor cell and receives the necessary information for accessing the non-anchor cells (or the system information of non-anchor cells) from the anchor cell, the UE can store the necessary information for accessing the non-anchor cells (or the system information of the non-anchor cells) received from the anchor cell. For a second example, after the UE receives the necessary information for accessing the non-anchor cells (or the system information of non-anchor cells) (e.g., non-anchor cells #1, #2, #3 and #4) from an anchor cell and stores the necessary information for accessing the non-anchor cells (or the system information of the non-anchor cells), the UE may later receive updated necessary information for accessing some of the non-anchor cells (or updated system information of some of the non-anchor cells) (e.g., non-anchor cells #1 and #2) from the anchor cell or from another anchor cell. It implies that the necessary information for accessing the other non-anchor cells (or the system information of the other non-anchor cells) (e.g., non-anchor cells #3 and #4) can be regarded as not being updated. So, the UE can use the necessary information for accessing the other non-anchor cells (or the system information of the other non-anchor cells) (e.g., non-anchor cells #3 and #4) that is stored in the UE.

When the UE knows the necessary information for accessing a non-anchor cell (or the system information of the non-anchor cell that includes the necessary information for accessing the non-anchor cell), the UE can access the non-anchor cell. It implies that, at any timing, the UE can access the anchor cell on which it camps and non-anchor cells where the necessary information for accessing the non-anchor cell (or the system information of the non-anchor cells) is known by the UE (e.g., the necessary information for accessing the non-anchor cells (or the system information of the non-anchor cells) is received from the anchor cell on which it camps or stored previously).

As a whole, it is possible that one anchor cell (i.e., the anchor cell on which the UE camps) and one or more non-anchor cells (where the necessary information for accessing the one or more non-anchor cells (or the system information of the one or more non-anchor cells) is known by the UE) can be accessed by the UE.

According to a first embodiment, UE determines a cell for accessing from the anchor cell and the one or more non-anchor cells.

The first embodiment proposes several conditions to determine the cell for accessing from the anchor cell (i.e., the anchor cell on which the UE camps) and the one or more non-anchor cells (where the necessary information for accessing the one or more non-anchor cells (or the system information of the one or more non-anchor cells) is known by the UE or is received by the UE).

One of Conditions 1-1, 1-2, 1-3, 1-4, 1-5, 1-6, 1-7, 1-8 and 1-9 can be applied as the condition to determine the cell for accessing from the anchor cell and the one or more non-anchor cells. For example, if each non-anchor cell is prioritized than the anchor cell to be determined as the cell for accessing, one of Conditions 1-1, 1-2, 1-3, 1-4, 1-5, 1-6, 1-7, 1-8 and 1-9 can be applied.

Condition 1-1: If the quality of each of first non-anchor cell(s) (where the first non-anchor cell(s) are some or all of the one or more non-anchor cells) is better than the quality of the anchor cell (e.g., its channel quality (e.g., RSRP) is better than the channel quality of the anchor cell, or the measured L1 or L2 or L3 cell quality or channel quality) is better than that of the anchor cell), the UE accesses one (e.g., any one or the best one) of the first non-anchor cell(s). In other words, the UE accesses one (e.g., any one or the best one) of first non-anchor cell(s), where the quality of each of the first non-anchor cell(s) is better than the quality of the anchor cell.

Condition 1-2: If each of second non-anchor cell(s) (where the second non-anchor cell(s) are some or all of the one or more non-anchor cells) satisfies cell reselection criteria (e.g., is a higher frequency priority cell that satisfies the cell reselection criteria), the UE accesses one (e.g., any one or the best one) of the second non-anchor cell(s). In other words, the UE accesses one (e.g., any one or the best one) of second non-anchor cell(s), where each of the second non-anchor cell(s) satisfies cell reselection criteria (e.g., is a higher frequency priority cell that satisfies the cell reselection criteria).

Condition 1-3: If each of third non-anchor cell(s) (where the third non-anchor cell(s) are some or all of the one or more non-anchor cells) satisfies cell selection criteria (e.g., S criterion), the UE accesses one (e.g., any one or the best one) of the third non-anchor cell(s). In other words, the UE accesses one (e.g., any one or the best one) of third non-anchor cell(s), where each of the third non-anchor cell(s) satisfies cell selection criteria (e.g., S criterion).

Condition 1-4: If the quality (e.g., the measured L1 or L2 or L3 cell quality or channel quality) of each of fourth non-anchor cell(s) (where the fourth non-anchor cell(s) are some or all of the one or more non-anchor cells) is better than a threshold, the UE accesses one (e.g., any one or the best one) of the fourth non-anchor cell(s). In other words, the UE accesses one (e.g., any one or the best one) of fourth non-anchor cell(s), where the quality of each of the fourth non-anchor cell(s) is better than a threshold.

Condition 1-5: If each of fifth non-anchor cell(s) (where the fifth non-anchor cell(s) are some or all of the one or more non-anchor cells) satisfies legacy suitable cell definition or legacy acceptable cell definition, the UE accesses one (e.g., any one or the best one) of the fifth non-anchor cell(s). In other words, the UE accesses one (e.g., any one or the best one) of fifth non-anchor cell(s), where each of the fifth non-anchor cell(s) satisfies legacy suitable cell definition or legacy acceptable cell definition. In legacy, a suitable cell is one for which the measured cell attributes satisfy the cell selection criteria; the cell PLMN is the selected PLMN, registered or an equivalent PLMN; the cell is not barred or reserved and the cell is not part of a tracking area which is in the list of “forbidden tracking areas for roaming”, while an acceptable cell is one for which the measured cell attributes satisfy the cell selection criteria and the cell is not barred.

Condition 1-6: If each of sixth non-anchor cell(s) (where the sixth non-anchor cell(s) are some or all of the one or more non-anchor cells) satisfies at least two of Conditions 1-1, 1-2, 1-3, 1-4 and 1-5, the UE accesses one (e.g., any one or the best one) of the sixth non-anchor cell(s). In other words, the UE accesses one (e.g., any one or the best one) of sixth non-anchor cell(s), where each of the sixth non-anchor cell(s) satisfies at least two of Conditions 1-1, 1-2, 1-3, 1-4 and 1-5. For example, each of the sixth non-anchor cell(s) satisfying Conditions 1-1 and 1-2 means that each of the sixth non-anchor cell(s) is better than the anchor cell and satisfies cell reselection criteria.

Condition 1-7: The UE accesses one (e.g., any one or the best one) of the one or more non-anchor cells.

Condition 1-8: The UE accesses the cell indicated by the network (e.g., by a gNB that manages the anchor cell). The cell indicated by the network may be a non-anchor cell (where the necessary information for accessing the non-anchor cell (or the system information of the non-anchor cell) is known or received by the UE) or the anchor cell. Incidentally, the detailed implementation of the indication is out of the scope of this disclosure. Condition 1-8 can be divided into Condition 1-8-1: the non-anchor cell indicated by the network; and Condition 1-8-2: the anchor cell indicated by the network.

Condition 1-9: If no non-anchor cell is determined according to any of Conditions 1-1, 1-2, 1-3, 1-4, 1-5, 1-6, 1-7 and 1-8, the UE accesses the anchor cell.

As a whole, if the necessary information for accessing a non-anchor cell (or the system information of the non-anchor cell) is known or received by the UE, and the non-anchor cell satisfies one of Conditions 1-1, 1-2, 1-3, 1-4, 1-5, 1-6, 1-7 and 1-8-1, the non-anchor cell can be determined as the cell for accessing. Otherwise, the anchor cell (indicated by the network as in Condition 1-8-2, or determined according to Condition 1-9) is determined as the cell for accessing.

Alternatively, one of Conditions 1′-2, 1′-3, 1′-4, 1′-5, 1′-6, 1′-7 and 1′-8 can be applied as the condition to determine the cell for accessing from the anchor cell and the one or more non-anchor cells. For example, if the anchor cell and the one or more non-anchor cells have the same priority to be determined as the cell for accessing, one of Conditions 1′-2, 1′-3, 1′-4, 1′-5, 1′-6, 1′-7 and 1′-8 can be applied.

Each of Conditions 1′-2, 1′-3, 1′-4, 1′-5, 1′-6, 1′-7, 1′-8 is similar to each of Conditions 1-2, 1-3, 1-4, 1-5, 1-6, 1-7, 1-8, respectively. There is no Condition 1′-1.

Condition 1′-2: Similar to Condition 1-2, the UE accesses one (e.g., any one or the best one) of second cells (where the second cells include the anchor cell and some or all of the one or more non-anchor cells), where each of the second cells satisfies cell reselection criteria (e.g., is a higher frequency priority cell that satisfies the cell reselection criteria).

Condition 1′-3: Similar to Condition 1-3, the UE accesses one (e.g., any one or the best one) of third cells (where the third cells include the anchor cell and some or all of the one or more non-anchor cells), where each of the third cells satisfies cell selection criteria (e.g., S criterion).

Condition 1′-4: Similar to Condition 1-4, the UE accesses one (e.g., any one or the best one) of fourth cells (where the fourth cells include the anchor cell and some or all of the one or more non-anchor cells), where the quality of each of the non-anchor cells is better than a threshold.

Condition 1′-5: Similar to Condition 1-5, the UE accesses one (e.g., any one or the best one) of fifth cells (where the fifth cells include the anchor cell and some or all of the one or more non-anchor cells), where each of the fifth cells satisfies legacy suitable cell definition or legacy acceptable cell definition.

Condition 1′-6: Similar to Condition 1-6, the UE accesses one (e.g., any one or the best one) of sixth cells (where the sixth cells include the anchor cell and some or all of the one or more non-anchor cells), where each of the sixth cells satisfies at least two of Conditions 1′-2, 1′-3, 1′-4 and 1′-5.

Condition 1′-7: Similar to Condition 1-7, the UE accesses one (e.g., any one or the best one) of ‘the anchor cell and the one or more non-anchor cells’.

Condition 1′-8: Similar to Condition 1-8, the UE accesses the cell indicated by the network (e.g., by a gNB that manages the anchor cell). The cell indicated by the network may be a non-anchor cell (where the necessary information for accessing the non-anchor cell (or the system information of the non-anchor cell) is known or received by the UE) or the anchor cell.

A second embodiment relates to the timing to determine the cell for accessing.

The second embodiment proposes several timings to determine the cell for accessing.

Timing 2-1: UE is triggered to perform state transition (e.g., from RRC_IDLE state or RRC_INACTIVE state to RRC_CONNECTED state, or a RACH procedure is triggered), e.g., when UL data arrives.

Timing 2-2: the UE that camps on an anchor cell receives the necessary information associated with accessing the one or more non-anchor cells from the anchor cell.

Timing 2-3: the UE that camps on an anchor cell receives new (e.g., updated or newly received) necessary information associated with accessing some or all of the one or more non-anchor cells from the anchor cell.

As whole, at any of the Timings 2-1, 2-2 and 2-3, the UE determines the cell for accessing (e.g., according to any condition described in the first embodiment).

According to the first embodiment, the cell for accessing is determined directly by one of the Conditions 1-1, 1-2, 1-3, 1-4, 1-5, (1-6), (1-7) and (1-8). As an alternative manner, candidate cells for accessing can be first determined before the cell for accessing is determined from the candidate cells.

A third embodiment relates to determining candidate cells for accessing from the anchor cell and the one or more non-anchor cells. Each candidate cell is a possible cell for accessing that is determined before the cell for accessing is determined.

The third embodiment proposes several conditions to determine the candidate cell(s) from the anchor cell (i.e., the anchor cell on which the UE camps) and the one or more non-anchor cells (where the necessary information for accessing the one or more non-anchor cells (or the system information of the one or more non-anchor cells) is known or received by the UE).

Condition 3-1: Similar to Condition 1-1, if the quality of each of first non-anchor cell(s) (where the first non-anchor cell(s) are some or all of the one or more non-anchor cells) is better than the quality of the anchor cell (e.g., its channel quality (e.g., RSRP) is better than the channel quality of the anchor cell, or the measured L1 or L2 or L3 cell quality or channel quality) is better than that of the anchor cell), the candidate cells include the first non-anchor cell(s). In other words, the candidate cells include first non-anchor cell(s), where the quality of each of the first non-anchor cell(s) is better than the quality of the anchor cell.

Condition 3-2: Similar to Condition 1-2, if each of second non-anchor cell(s) (where the second non-anchor cell(s) are some or all of the one or more non-anchor cells) satisfies cell reselection criteria (e.g., is a higher frequency priority cell that satisfies the cell reselection criteria), the candidate cells include the second non-anchor cell(s). In other words, the candidate cells include second non-anchor cell(s), where each of the second non-anchor cell(s) satisfies cell reselection criteria (e.g., is a higher frequency priority cell that satisfies the cell reselection criteria).

Condition 3-3: Similar to Condition 1-3, if each of third non-anchor cell(s) (where the third non-anchor cell(s) are some or all of the one or more non-anchor cells) satisfies cell selection criteria (e.g., S criterion), the candidate cells include the third non-anchor cell(s). In other words, the candidate cells include third non-anchor cell(s), where each of the third non-anchor cell(s) satisfies cell selection criteria (e.g., S criterion).

Condition 3-4: Similar to Condition 1-4, if the quality (e.g., the measured L1 or L2 or L3 cell quality or channel quality) of each of fourth non-anchor cell(s) (where the fourth non-anchor cell(s) are some or all of the one or more non-anchor cells) is better than a threshold, the candidate cells include the fourth non-anchor cell(s). In other words, the candidate cells include fourth non-anchor cell(s), where the quality of each of the fourth non-anchor cell(s) is better than a threshold.

Condition 3-5: Similar to Condition 1-5, if each of fifth non-anchor cell(s) (where the fifth non-anchor cell(s) are some or all of the one or more non-anchor cells) satisfies legacy suitable cell definition or legacy acceptable cell definition, the candidate cells include the fifth non-anchor cell(s). In other words, the candidate cells include fifth non-anchor cell(s), where each of the fifth non-anchor cell(s) satisfies legacy suitable cell definition or legacy acceptable cell definition.

Condition 3-6: Similar to Condition 1-6, if each of sixth non-anchor cell(s) (where the sixth non-anchor cell(s) are some or all of the one or more non-anchor cells) satisfies at least two of Conditions 3-1, 3-2, 3-3, 3-4 and 3-5, the candidate cells include the sixth non-anchor cell(s). In other words, the candidate cells include sixth non-anchor cell(s), where each of the sixth non-anchor cell(s) satisfies at least two of Conditions 3-1, 3-2, 3-3, 3-4 and 3-5. For example, the sixth non-anchor cell(s) satisfying Conditions 3-1 and 3-3 means that the candidate cells include the sixth non-anchor cell(s), where each of the sixth non-anchor cell(s) is better than the anchor cell and satisfies cell selection criteria.

Condition 3-7: Similar to Condition 1-7, the candidate cells include all of the one or more non-anchor cells.

In addition to each of Conditions 3-1, 3-2, 3-3, 3-4, 3-5, 3-6 and 3-7, the candidate cells may further include the anchor cell.

As a whole, the candidate cells include the non-anchor cell(s) that satisfy any of Conditions 3-1, 3-2, 3-3, 3-4, 3-5, 3-6 and 3-7, and the anchor cell.

A fourth embodiment relates to determining the cell for accessing from the candidate cells (e.g., the candidate cells determined according to the third embodiment). Obviously, if there is only one candidate cell, the one candidate cell is determined as the cell for accessing.

The fourth embodiment proposes several conditions to determine the cell for accessing from the candidate cells that include at least two candidate cells.

As described in the third embodiment, the candidate cells include the non-anchor cell(s) that satisfy any of Conditions 3-1, 3-2, 3-3, 3-4, 3-5, 3-6 and 3-7, and the anchor cell. It means that the candidate cells include candidate non-anchor cell(s) and the candidate anchor cell (i.e., the anchor cell).

One of Conditions 4-1, 4-2, 4-3, 4-4, 4-5, 4-6, 4-7 and 4-8 can be applied as the condition to determine the cell for accessing from the candidate cells. For example, if each non-anchor cell is prioritized than the candidate anchor cell (the candidate anchor cell is the anchor cell) to be determined as the cell for accessing, one of Conditions 4-1, 4-2, 4-3, 4-4, 4-5, 4-6, 4-7 and 4-8 can be applied.

In each of Conditions 4-1, 4-2, 4-3, 4-4, 4-5, 4-6 and 4-7, a candidate non-anchor cell is determined from the candidate non-anchor cell(s) as the cell for accessing.

Condition 4-1: Similar to Condition 1-1, if the quality of each of first candidate non-anchor cell(s) (where the first candidate non-anchor cell(s) are some or all of the candidate non-anchor cell(s)) is better than the quality of the anchor cell (e.g., its channel quality (e.g., RSRP) is better than the channel quality of the anchor cell, or the measured L1 or L2 or L3 cell quality or channel quality) is better than that of the anchor cell), one (e.g., any one or the best one) of the first candidate non-anchor cell(s) is determined as the cell for accessing. In other words, one (e.g., any one or the best one) of first candidate non-anchor cell(s) is determined as the cell for accessing, where the quality of each of the first candidate non-anchor cell(s) is better than the quality of the anchor cell.

Condition 4-2: Similar to Condition 1-2: if each of second candidate non-anchor cell(s) (where the second candidate non-anchor cell(s) are some or all of the candidate non-anchor cell(s)) satisfies cell reselection criteria (e.g., is a higher frequency priority cell that satisfies the cell reselection criteria), one (e.g., any one or the best one) of the second candidate non-anchor cell(s) is determined as the cell for accessing. In other words, one (e.g., any one or the best one) of second candidate non-anchor cell(s) is determined as the cell for accessing, where each of the second candidate non-anchor cell(s) satisfies cell reselection criteria (e.g., is a higher frequency priority cell that satisfies the cell reselection criteria).

Condition 4-3: Similar to Condition 1-3, if each of third candidate non-anchor cell(s) (where the third candidate non-anchor cell(s) are some or all of the candidate non-anchor cell(s)) satisfies cell selection criteria (e.g., S criterion), one (e.g., any one or the best one) of the third candidate non-anchor cell(s) is determined as the cell for accessing. In other words, one (e.g., any one or the best one) of third candidate non-anchor cell(s) is determined as the cell for accessing, where each of the third candidate non-anchor cell(s) satisfies cell selection criteria (e.g., S criterion).

Condition 4-4: Similar to Condition 1-4, if the quality (e.g., the measured L1 or L2 or L3 cell quality or channel quality) of each of fourth candidate non-anchor cell(s) (where the fourth candidate non-anchor cell(s) are some or all of the candidate non-anchor cell(s)) is better than a threshold, one (e.g., any one or the best one) of the fourth candidate non-anchor cell(s) is determined as the cell for accessing. In other words, one (e.g., any one or the best one) of fourth candidate non-anchor cell(s) is determined as the cell for accessing, where the quality of each of the fourth candidate non-anchor cell(s) is better than a threshold.

Condition 4-5: Similar to Condition 1-5, if each of fifth candidate non-anchor cell(s) (where the fifth candidate non-anchor cell(s) are some or all of the candidate non-anchor cell(s)) satisfies legacy suitable cell definition or legacy acceptable cell definition, one (e.g., any one or the best one) of the fifth candidate non-anchor cell(s) is determined as the cell for accessing. In other words, one (e.g., any one or the best one) of fifth candidate non-anchor cell(s) is determined as the cell for accessing, where each of the fifth candidate non-anchor cell(s) satisfies legacy suitable cell definition or legacy acceptable cell definition.

Condition 4-6: Similar to Condition 1-6, if each of sixth candidate non-anchor cell(s) (where the sixth candidate non-anchor cell(s) are some or all of the candidate non-anchor cell(s)) satisfies at least two of Conditions 4-1, 4-2, 4-3, 4-4 and 4-5, one (e.g., any one or the best one) of the sixth candidate non-anchor cell(s) is determined as the cell for accessing. In other words, one (e.g., any one or the best one) of sixth candidate non-anchor cell(s) is determined as the cell for accessing, where each of the sixth candidate non-anchor cell(s) satisfies at least two of Conditions 4-1, 4-2, 4-3, 4-4 and 4-5. For example, each of the sixth candidate non-anchor cell(s) satisfying Conditions 4-1 and 4-2 means that each of the sixth candidate non-anchor cell(s) is better than the anchor cell and satisfies cell reselection criteria.

Condition 4-7: one (e.g., any one or the best one) of the candidate non-anchor cell(s) is determined as the cell for accessing.

Condition 4-8: If no non-anchor cell is determined according to any of Conditions 4-1, 4-2, 4-3, 4-4, 4-5, 4-6 and 4-7, the anchor cell included in the candidate cells is determined as the cell for accessing.

As a whole, if a non-anchor candidate cell satisfies one of Conditions 4-1, 4-2, 4-3, 4-4, 4-5, 4-6 and 4-7, the non-anchor candidate cell can be determined as the cell for accessing. Otherwise, the anchor cell is determined as the cell for accessing (Condition 4-8).

Alternatively, one of Conditions 4′-2, 4′-3, 4′-4, 4′-5, 4′-6 and 4′-7 can be applied as the condition to determine the cell for accessing from the candidate cells. For example, if the anchor cell (candidate anchor cell) and the candidate non-anchor cell(s) have the same priority to be determined as the cell for accessing, one of Conditions 4′-2, 4′-3, 4′-4, 4′-5, 4′-6 and 4′-7 can be applied.

Each of Conditions 4′-2, 4′-3, 4′-4, 4′-5, 4′-6 and 4′-7 is similar to each of Conditions 4-2, 4-3, 4-4, 4-5, 4-6 and 4-7, respectively. There is no Condition 4′-1.

Condition 4′-2: Similar to Condition 4-2: one (e.g., any one or the best one) of second candidate cells (where the second candidate cells include the anchor cell and some or all of the candidate non-anchor cell(s)) is determined as the cell for accessing, where each of the second candidate cells satisfies cell reselection criteria (e.g., is a higher frequency priority cell that satisfies the cell reselection criteria).

Condition 4′-3: Similar to Condition 4-3, one (e.g., any one or the best one) of third candidate cells (where the third candidate cells include the anchor cell and some or all of the candidate non-anchor cell(s)) is determined as the cell for accessing, where each of the third candidate cells satisfies cell selection criteria (e.g., S criterion).

Condition 4′-4: Similar to Condition 4-4, one (e.g., any one or the best one) of fourth candidate cells (where the fourth candidate cells include the anchor cell and some or all of the candidate non-anchor cell(s)) is determined as the cell for accessing, where the quality of each of the fourth candidate cells is better than a threshold.

Condition 4′-5: Similar to Condition 4-5, one (e.g., any one or the best one) of fifth candidate cells (where the fifth candidate cells include the anchor cell and some or all of the candidate non-anchor cell(s)) is determined as the cell for accessing, where each of the fifth candidate cells satisfies legacy suitable cell definition or legacy acceptable cell definition.

Condition 4′-6: Similar to Condition 4-6, one (e.g., any one or the best one) of sixth candidate cells (where the sixth candidate cells include the anchor cell and some or all of the candidate non-anchor cell(s)) is determined as the cell for accessing, where each of the sixth candidate cells satisfies at least two of Conditions 4′-2, 4′-3, 4′-4 and 4′-5.

Condition 4′-7: one (e.g., any one or the best one) of the candidate cells is determined as the cell for accessing.

A fifth embodiment relates to the timing to determine the candidate cells.

The fifth embodiment proposes several timings to determine the candidate cells.

Timing 5-1: Similar to Timing 2-1, UE is triggered to perform state transition (e.g., from RRC_IDLE state or RRC_INACTIVE state to RRC_CONNECTED state, or a RACH procedure is triggered), e.g., when UL data arrives.

Timing 5-2: Similar to Timing 2-2, the UE that camps on an anchor cell receives the necessary information associated with accessing the one or more non-anchor cells from the anchor cell.

Timing 5-3: Similar to Timing 2-3, the UE that camps on an anchor cell receives new (e.g., updated or newly received) necessary information associated with accessing some or all of the one or more non-anchor cells from the anchor cell.

As whole, at any of the Timings 5-1, 5-2 and 5-3, the UE determines the candidate cells (e.g., according to the third embodiment)

Once the candidate cells are determined, the cell for accessing can be determined from the candidate cells by one of the Conditions 4-1, 4-2, 4-3, 4-4, 4-5, 4-6, 4-7 and 4-8 according to the fourth embodiment. In view of the above, an extra timing to determine the cell for accessing can be Timing 2-4: after determining the candidate cells. It means that, at Timing 2-4, the UE determines the cell for accessing (e.g., according to any condition described in the fourth embodiment).

A sixth embodiment is related to multi-carrier scenario.

A few concepts related to carrier aggregation and dual connectivity are clarified.

MCG stands for Master Cell group, while SCG stands for Secondary Cell group. MCG and SCG can be regarded as concepts in dual connectivity. For simplicity, the group that includes the cell to which the UE initiates RACH is MCG, while the group that does not include the cell to which the UE initiates RACH is SCG. If no dual connectivity is configured, there is only one group of cells, which can also be understood as MCG.

MCG includes multiple cells, in which the cell for initial access in MCG is referred to as PCell (Primary Cell), while the other cell(s) in MCG are referred to as SCell(s) (Secondary Cell). The PCell and the SCell(s) in MCG can be combined by carrier aggregation (CA).

Similarly, SCG includes multiple cells, in which the cell for initial access in SCG is referred to as PSCell (Primary Secondary Cell), while the other cell(s) in SCG are also referred to as SCell(s). The PSCell and the SCell(s) in SCG can also be combined by CA.

Because the necessary information for accessing the non-anchor cell(s) are needed for the UE to access the non-anchor cell(s), according to the sixth embodiment, the anchor cell(s) that provide the necessary information for accessing the non-anchor cell(s) or the cell group (e.g., SCG) including the anchor cell(s) are not allowed to be deactivated. It means that, if the UE is configured with a cell or a cell group that includes the cell while the cell is one of the anchor cells that provide the necessary information for accessing the non-anchor cell(s) for the UE, the cell or the cell group including the cell is not allowed to be deactivated.

For example, the cell, that is one of the anchor cells that provide the necessary information for accessing the non-anchor cell(s) for the UE, can be configured as PCell or SCell in MCG or PSCell or SCell in SCG.

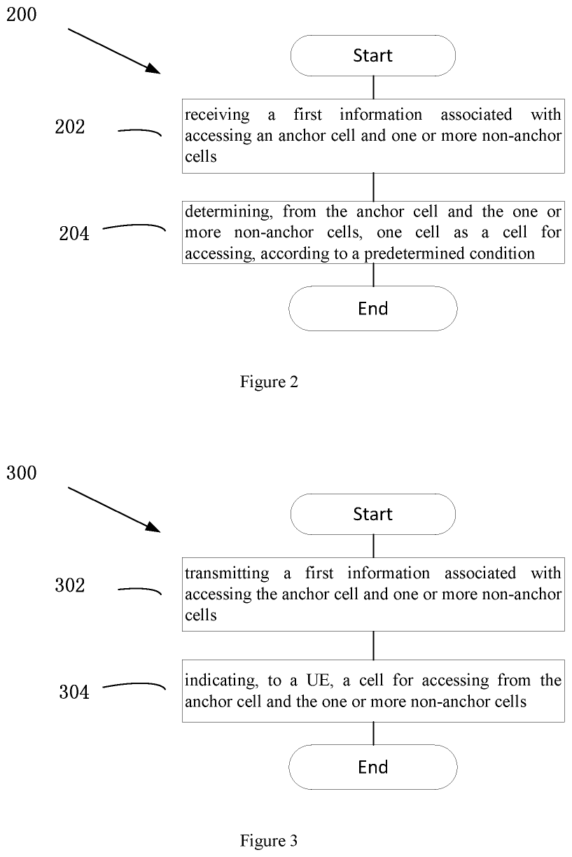

FIG. 2 is a schematic flow chart diagram illustrating an embodiment of a method 200 according to the present application. In some embodiments, the method 200 is performed by an apparatus, such as a remote unit (UE). In certain embodiments, the method 200 may be performed by a processor executing program code, for example, a microcontroller, a microprocessor, a CPU, a GPU, an auxiliary processing unit, a FPGA, or the like.

The method 200 may be performed by a UE that supports network energy saving (NES), the method comprises 202 receiving a first information associated with accessing an anchor cell and one or more non-anchor cells; and 204 determining, from the anchor cell and the one or more non-anchor cells, one cell as a cell for accessing, according to a predetermined condition.

In some embodiment, the predetermined condition includes a first predetermined condition, wherein the first predetermined condition includes one of: Condition 1-1: one of the one or more non-anchor cells, the quality of each of which is better than the quality of the anchor cell; Condition 1-2: one of the one or more non-anchor cells, each of which satisfies cell reselection criteria; Condition 1-3: one of the one or more non-anchor cell(s), each of which satisfies cell selection criteria; Condition 1-4: one of the one or more non-anchor cells, the quality of each of which is better than a threshold; Condition 1-5: one of the one or more non-anchor cells, each of which satisfies suitable cell definition or acceptable cell definition; and Condition 1-6: one of the one or more non-anchor cells, each of which satisfies at least two of Conditions 1-1, 1-2, 1-3, 1-4 and 1-5. The anchor cell is determined as the cell for accessing if no non-anchor cell is determined according to the first predetermined condition.

Alternatively, the predetermined condition includes a first predetermined condition, wherein the first predetermined condition includes one of: Condition 1′-2: one of the anchor cell and the one or more non-anchor cells, each of which satisfies cell reselection criteria; Condition 1′-3: one of the anchor cell and the one or more non-anchor cells, each of which satisfies cell selection criteria; Condition 1′-4: one of the anchor cell and the one or more non-anchor cells, the quality of each of which is better than a threshold; Condition 1′-5: one of the anchor cell and the one or more non-anchor cells, each of which satisfies suitable cell definition or acceptable cell definition; and Condition 1′-6: one of the anchor cell and the one or more non-anchor cells, each of which satisfies at least two of Conditions 1′-2, 1′-3, 1′-4 and 1′-5.

In some embodiment, the cell for accessing is determined according to an indication from the network.

In some embodiment, the first information associated with accessing the one or more non-anchor cells is received from one or more anchor cells; and if the UE is configured with a second cell or a cell group that includes the second cell where the second cell is one of the one or more anchor cells, the second cell or the cell group that includes the second cell is not allowed to be deactivated.

In some embodiment, the predetermined condition includes a second predetermined condition and a third predetermined condition, candidate cells are determined from the anchor cell and the one or more non-anchor cells according to the second predetermined condition, wherein, the candidate cells include the anchor cell and candidate non-anchor cell(s), and the cell for accessing is determined from the determined candidate cells according to the third predetermined condition.

In some embodiment, the second predetermined condition includes one of Condition 3-1: the one or more non-anchor cells, the quality of each of which is better than the quality of the anchor cell; Condition 3-2: the one or more non-anchor cells, each of which satisfies cell reselection criteria; Condition 3-3: the one or more non-anchor cells, each of which satisfies cell selection criteria; Condition 3-4: the one or more non-anchor cells, the quality of each of which is better than a threshold; Condition 3-5: the one or more non-anchor cells, each of which satisfies suitable cell definition or acceptable cell definition; and Condition 3-6: the one or more non-anchor cells, each of which satisfies at least two of Conditions 3-1, 3-2, 3-3, 3-4 and 3-5.

In some embodiment, the third predetermined condition includes one of Condition 4-1: one of the candidate non-anchor cell(s), the quality of each of which is better than the quality of the anchor cell; Condition 4-2: one of the candidate non-anchor cell(s), each of which satisfies cell reselection criteria; Condition 4-3: one of the candidate non-anchor cell(s), each of which satisfies cell selection criteria; Condition 4-4: one of the candidate non-anchor cell(s), the quality of each of which is better than a threshold; Condition 4-5: one of the candidate non-anchor cell(s), each of which satisfies suitable cell definition or acceptable cell definition; and Condition 4-6: one of the candidate non-anchor cell(s), each of which satisfies at least two of Conditions 4-1, 4-2, 4-3, 4-4 and 4-5. The anchor cell is determined as the cell for accessing if no non-anchor cell is determined according to the third predetermined condition.

Alternatively, the third predetermined condition includes one of Condition 4′-2: one of the candidate cells, each of which satisfies cell reselection criteria; Condition 4′-3: one of the candidate cells, each of which satisfies cell selection criteria; Condition 4′-4: one of the candidate cells, the quality of each of which is better than a threshold; Condition 4′-5: one of the candidate cells, each of which satisfies suitable cell definition or acceptable cell definition; and Condition 4′-6: one of the candidate cells, each of which satisfies at least two of Conditions 4′-2, 4′-3, 4′-4 and 4′-5.

In some embodiment, the cell for accessing is determined at one of Timing 2-1: the UE is triggered to perform state transition; Timing 2-2: the UE that camps on an anchor cell receives the first information associated with accessing the one or more non-anchor cells from the anchor cell; Timing 2-3: the UE that camps on an anchor cell receives updated first information associated with accessing some or all of the one or more non-anchor cells from the anchor cell; and Timing 2-4: after determining candidate cells.

In some embodiment, the candidate cells are determined at one of Timing 5-1: the UE is triggered to perform state transition; Timing 5-2: the UE that camps on an anchor cell receives the first information associated with accessing the one or more non-anchor cells from the anchor cell; and Timing 5-3: the UE that camps on an anchor cell receives updated first information associated with accessing some or all of the one or more non-anchor cells from the anchor cell.

FIG. 3 is a schematic flow chart diagram illustrating a further embodiment of a method 300 according to the present application. In some embodiments, the method 300 is performed by an apparatus, such as a base unit or a network device. In certain embodiments, the method 300 may be performed by a processor executing program code, for example, a microcontroller, a microprocessor, a CPU, a GPU, an auxiliary processing unit, a FPGA, or the like.

The method 300 may be performed by a network device, wherein, the network device manages an anchor cell, and the method comprises 302 transmitting a first information associated with accessing the anchor cell and one or more non-anchor cells; and 304 indicating, to a UE, a cell for accessing from the anchor cell and the one or more non-anchor cells.

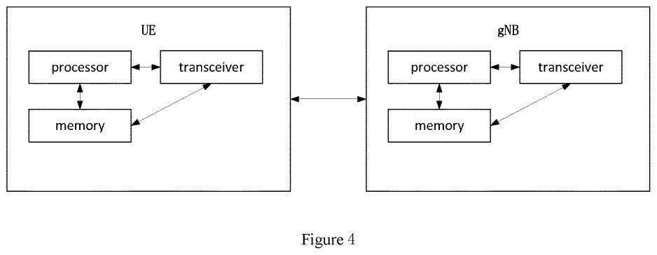

FIG. 4 is a schematic block diagram illustrating apparatuses according to one embodiment.

Referring to FIG. 4, the UE (i.e., remote unit, or terminal device) includes a processor, a memory, and a transceiver. The processor implements a function, a process, and/or a method which are proposed in FIG. 2.

The UE comprises a processor; and a transceiver coupled to the processor, wherein, the UE supports network energy saving (NES), and the processor is configured to receive, via the transceiver, a first information associated with accessing an anchor cell and one or more non-anchor cells; and determine, from the anchor cell and the one or more non-anchor cells, one cell as a cell for accessing, according to a predetermined condition.

In some embodiment, the predetermined condition includes a first predetermined condition, wherein the first predetermined condition includes one of: Condition 1-1: one of the one or more non-anchor cells, the quality of each of which is better than the quality of the anchor cell; Condition 1-2: one of the one or more non-anchor cells, each of which satisfies cell reselection criteria; Condition 1-3: one of the one or more non-anchor cell(s), each of which satisfies cell selection criteria; Condition 1-4: one of the one or more non-anchor cells, the quality of each of which is better than a threshold; Condition 1-5: one of the one or more non-anchor cells, each of which satisfies suitable cell definition or acceptable cell definition; and Condition 1-6: one of the one or more non-anchor cells, each of which satisfies at least two of Conditions 1-1, 1-2, 1-3, 1-4 and 1-5. The anchor cell is determined as the cell for accessing if no non-anchor cell is determined according to the first predetermined condition.

Alternatively, the predetermined condition includes a first predetermined condition, wherein the first predetermined condition includes one of: Condition 1′-2: one of the anchor cell and the one or more non-anchor cells, each of which satisfies cell reselection criteria; Condition 1′-3: one of the anchor cell and the one or more non-anchor cells, each of which satisfies cell selection criteria; Condition 1′-4: one of the anchor cell and the one or more non-anchor cells, the quality of each of which is better than a threshold; Condition 1′-5: one of the anchor cell and the one or more non-anchor cells, each of which satisfies suitable cell definition or acceptable cell definition; and Condition 1′-6: one of the anchor cell and the one or more non-anchor cells, each of which satisfies at least two of Conditions 1′-2, 1′-3, 1′-4 and 1′-5.

In some embodiment, the cell for accessing is determined according to an indication from the network.

In some embodiment, the first information associated with accessing the one or more non-anchor cells is received from one or more anchor cells; and if the UE is configured with a second cell or a cell group that includes the second cell where the second cell is one of the one or more anchor cells, the second cell or the cell group that includes the second cell is not allowed to be deactivated.

In some embodiment, the predetermined condition includes a second predetermined condition and a third predetermined condition, candidate cells are determined from the anchor cell and the one or more non-anchor cells according to the second predetermined condition, wherein, the candidate cells include the anchor cell and candidate non-anchor cell(s), and the cell for accessing is determined from the determined candidate cells according to the third predetermined condition.

In some embodiment, the second predetermined condition includes one of Condition 3-1: the one or more non-anchor cells, the quality of each of which is better than the quality of the anchor cell; Condition 3-2: the one or more non-anchor cells, each of which satisfies cell reselection criteria; Condition 3-3: the one or more non-anchor cells, each of which satisfies cell selection criteria; Condition 3-4: the one or more non-anchor cells, the quality of each of which is better than a threshold; Condition 3-5: the one or more non-anchor cells, each of which satisfies suitable cell definition or acceptable cell definition; and Condition 3-6: the one or more non-anchor cells, each of which satisfies at least two of Conditions 3-1, 3-2, 3-3, 3-4 and 3-5.

In some embodiment, the third predetermined condition includes one of Condition 4-1: one of the candidate non-anchor cell(s), the quality of each of which is better than the quality of the anchor cell; Condition 4-2: one of the candidate non-anchor cell(s), each of which satisfies cell reselection criteria; Condition 4-3: one of the candidate non-anchor cell(s), each of which satisfies cell selection criteria; Condition 4-4: one of the candidate non-anchor cell(s), the quality of each of which is better than a threshold; Condition 4-5: one of the candidate non-anchor cell(s), each of which satisfies suitable cell definition or acceptable cell definition; and Condition 4-6: one of the candidate non-anchor cell(s), each of which satisfies at least two of Conditions 4-1, 4-2, 4-3, 4-4 and 4-5. The anchor cell is determined as the cell for accessing if no non-anchor cell is determined according to the third predetermined condition.

Alternatively, the third predetermined condition includes one of Condition 4′-2: one of the candidate cells, each of which satisfies cell reselection criteria; Condition 4′-3: one of the candidate cells, each of which satisfies cell selection criteria; Condition 4′-4: one of the candidate cells, the quality of each of which is better than a threshold; Condition 4′-5: one of the candidate cells, each of which satisfies suitable cell definition or acceptable cell definition; and Condition 4′-6: one of the candidate cells, each of which satisfies at least two of Conditions 4′-2, 4′-3, 4′-4 and 4′-5.

In some embodiment, the cell for accessing is determined at one of Timing 2-1: the UE is triggered to perform state transition; Timing 2-2: the UE that camps on an anchor cell receives the first information associated with accessing the one or more non-anchor cells from the anchor cell; Timing 2-3: the UE that camps on an anchor cell receives updated first information associated with accessing some or all of the one or more non-anchor cells from the anchor cell; and Timing 2-4: after determining candidate cells.

In some embodiment, the candidate cells are determined at one of Timing 5-1: the UE is triggered to perform state transition; Timing 5-2: the UE that camps on an anchor cell receives the first information associated with accessing the one or more non-anchor cells from the anchor cell; and Timing 5-3: the UE that camps on an anchor cell receives updated first information associated with accessing some or all of the one or more non-anchor cells from the anchor cell.

Referring to FIG. 4, the gNB (i.e., base unit or network device) includes a processor, a memory, and a transceiver. The processor implements a function, a process, and/or a method which are proposed in FIG. 3.

The network device comprises a processor; and a transceiver coupled to the processor, wherein, the network device manages an anchor cell, and the processor is configured to transmit, via the transceiver, a first information associated with accessing the anchor cell and one or more non-anchor cells; and indicate, to a UE, a cell for accessing from the anchor cell and the one or more non-anchor cells.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A user equipment (UE) that supports network energy saving (NES), comprising:
at least one memory; and
at least one processor coupled with the at least one memory and configured to cause the UE to:
receive first information associated with accessing an anchor cell and one or more non-anchor cells; and
determine, from the anchor cell and the one or more non-anchor cells, one cell as a cell for accessing, according to a predetermined condition.

2. The UE of claim 1, wherein the predetermined condition includes a first predetermined condition, wherein the first predetermined condition includes one or more of: one of the one or more non-anchor cells, a quality of each of which is better than a quality of the anchor cell; one of the one or more non-anchor cells, each of which satisfies cell reselection criteria; one of the one or more non-anchor cell(s), each of which satisfies cell selection criteria; one of the one or more non-anchor cells, the quality of each of which is better than a threshold; and one of the one or more non-anchor cells, each of which satisfies suitable cell definition or acceptable cell definition.

3. The UE of claim 2, wherein the anchor cell is determined as the cell for accessing if no non-anchor cell is determined according to the first predetermined condition.

4. The UE of claim 1, wherein the predetermined condition includes a first predetermined condition, and wherein the first predetermined condition includes one or more of: one of the anchor cell and the one or more non-anchor cells, each of which satisfies cell reselection criteria; one of the anchor cell and the one or more non-anchor cells, each of which satisfies cell selection criteria; one of the anchor cell and the one or more non-anchor cells, a quality of each of which is better than a threshold; and one of the anchor cell and the one or more non-anchor cells, each of which satisfies suitable cell definition or acceptable cell definition.

5. The UE of claim 1, wherein the cell for accessing is determined according to an indication from the network.

6. The UE of claim 1, wherein the first information associated with accessing the one or more non-anchor cells is received from one or more anchor cells and, if the UE is configured with a second cell or a cell group that includes the second cell where the second cell is one of the one or more anchor cells, the second cell or the cell group that includes the second cell is not allowed to be deactivated.

7. The UE of claim 1, wherein the predetermined condition includes a second predetermined condition and a third predetermined condition, candidate cells are determined from the anchor cell and the one or more non-anchor cells according to the second predetermined condition, wherein, the candidate cells include the anchor cell and candidate non-anchor cell(s), and the cell for accessing is determined from the determined candidate cells according to the third predetermined condition.

8. The UE of claim 7, wherein the second predetermined condition includes one or more of: the one or more non-anchor cells, a quality of each of which is better than a quality of the anchor cell; the one or more non-anchor cells, each of which satisfies cell reselection criteria; the one or more non-anchor cells, each of which satisfies cell selection criteria; the one or more non-anchor cells, the quality of each of which is better than a threshold; and the one or more non-anchor cells, each of which satisfies suitable cell definition or acceptable cell definition.

9. The UE of claim 7, wherein the third predetermined condition includes one or more of: one of the candidate non-anchor cell(s), a quality of each of which is better than a quality of the anchor cell; one of the candidate non-anchor cell(s), each of which satisfies cell reselection criteria; one of the candidate non-anchor cell(s), each of which satisfies cell selection criteria; one of the candidate non-anchor cell(s), the quality of each of which is better than a threshold; and one of the candidate non-anchor cell(s), each of which satisfies suitable cell definition or acceptable cell definition.

10. The UE of claim 9, wherein the anchor cell is determined as the cell for accessing if no non-anchor cell is determined according to the third predetermined condition.

11. The UE of claim 7, wherein the third predetermined condition includes one or more of: one of the candidate cells, each of which satisfies cell reselection criteria; one of the candidate cells, each of which satisfies cell selection criteria; one of the candidate cells, a quality of each of which is better than a threshold; and one of the candidate cells, each of which satisfies suitable cell definition or acceptable cell definition.

12. The UE of claim 1, wherein the cell for accessing is determined at a time that one or more of: the UE is triggered to perform state transition; the UE that camps on an anchor cell receives the first information associated with accessing the one or more non-anchor cells from the anchor cell; the UE that camps on an anchor cell receives updated first information associated with accessing some or all of the one or more non-anchor cells from the anchor cell; and after determining candidate cells.

13. The UE of claim 7, wherein 9 the candidate cells are determined at a time that one or more of: the UE is triggered to perform state transition; the UE that camps on an anchor cell receives the first information associated with accessing the one or more non-anchor cells from the anchor cell; and the UE that camps on an anchor cell receives updated first information associated with accessing some or all of the one or more non-anchor cells from the anchor cell.

14. A method performed by a user equipment (UE), wherein, the UE supports network energy saving (NES), the method comprising:
receiving a first information associated with accessing an anchor cell and one or more non-anchor cells; and
determining, from the anchor cell and the one or more non-anchor cells, one cell as a cell for accessing, according to a predetermined condition.

15. A base station that manages an anchor cell, the base station comprising:
at least one memory; and
at least one processor coupled with the at least one memory and configured to cause the base station to:
transmit a first information associated with accessing the anchor cell and one or more non-anchor cells; and
indicate, to a user equipment (UE), a cell for accessing from the anchor cell and the one or more non-anchor cells.

16. A processor for wireless communication that supports network energy saving (NES), comprising:
at least one controller coupled with at least one memory and configured to cause the processor to:
receive a first information associated with accessing an anchor cell and one or more non-anchor cells; and
determine, from the anchor cell and the one or more non-anchor cells, one cell as a cell for accessing, according to a predetermined condition.

17. The processor of claim 16, wherein the predetermined condition includes a first predetermined condition, wherein the first predetermined condition includes one or more of: one of the one or more non-anchor cells, a quality of each of which is better than a quality of the anchor cell; one of the one or more non-anchor cells, each of which satisfies cell reselection criteria; one of the one or more non-anchor cell(s), each of which satisfies cell selection criteria; one of the one or more non-anchor cells, the quality of each of which is better than a threshold; and one of the one or more non-anchor cells, each of which satisfies suitable cell definition or acceptable cell definition.

18. The processor of claim 17, wherein the anchor cell is determined as the cell for accessing if no non-anchor cell is determined according to the first predetermined condition.

19. The processor of claim 16, wherein the predetermined condition includes a first predetermined condition, and wherein the first predetermined condition includes one or more of: one of the anchor cell and the one or more non-anchor cells, each of which satisfies cell reselection criteria; one of the anchor cell and the one or more non-anchor cells, each of which satisfies cell selection criteria; one of the anchor cell and the one or more non-anchor cells, a quality of each of which is better than a threshold; and one of the anchor cell and the one or more non-anchor cells, each of which satisfies suitable cell definition or acceptable cell definition.

20. The processor of claim 16, wherein the cell for accessing is determined according to an indication from the network.
